(19) United States
(12) Patent Application Publication
(10) Pub. No.: US 2008/0180768 A1
(43) Pub. Date: Jul. 31, 2008

(54) PHOTO DETECTING DEVICE AND HOLOGRAPHIC DATA REPRODUCING APPARATUS FOR MULTILAYERED HOLOGRAPHIC DATA STORAGE MEDIUM

(75) Inventors: Ji-deog KIM, Seoul (KR); Jong-su YI, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/951,569

(22) Filed: Dec. 6, 2007

(30) Foreign Application Priority Data
Jan. 30, 2007 (KR) 10-2007-0009547

(51) Int. Cl. G03H 1/26; G02B 5/32

(52) U.S. Cl. 359/15; 359/22

(57) ABSTRACT

Provided are a photo detecting device and a holographic data reproducing apparatus for a multilayered holographic data storage medium using the photo detecting device. The holographic data reproducing apparatus, which can reproduce a large amount of information recorded in multiple layers of a holographic data storage medium, includes a focusing lens focusing a plurality reproducing signal beams generated when a reference beam is incident on the holographic data storage medium and having focal points formed at different locations on the same optical axis, a volume hologram device generating secondary signal beams which travel in different directions by diffracting a plurality of reproducing signal beams having different focal points, a fourier lens focusing the secondary signal beams generated from the volume hologram device, and an optical detector array detecting the secondary signal beams focused by the fourier lens.

### CROSS-REFERENCE TO RELATED PATENT APPLICATION

This application claims priority from Korean Patent Application No. 10-2007-0009547, filed on Jan. 30, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relates to a photo detecting device and a holographic data reproducing apparatus for a multilayered holographic data storage medium using the same, and more particularly, to a photo detecting device which can detect a plurality of beams having focal points formed at different locations on the same optical axis and a data reproducing apparatus which can reproduce a plurality of signal beams formed from the multilayered holographic data storage medium which have different focal points.

2. Description of the Related Art

Recently, optical storage technology using holograms has attracted attention. A data storage method using holograms stores data in the form of an optical interference pattern in an inorganic crystal or polymer material which is photosensitive. The optical interference pattern is formed using two coherent laser beams. That is, a reference beam having no data and a signal beam having a predetermined data, interfere with each other forming an interference pattern and the interference pattern causes a chemical or physical change in a photosensitive storage medium, which enables recording. To reproduce data from the recorded interference pattern, a reference beam identical to the light beam used for recording is incident on the interference pattern recorded in the storage medium. Accordingly, the interference pattern diffracts the reference beam, so that a signal beam is restored and the data can be reproduced.

FIG. 1 shows the structure of a related art holographic data recording/reproducing apparatus. FIG. 2 shows data being recorded by a data recording apparatus in a data storage medium using the interference between a reference beam and a signal beam.

Referring to FIGS. 1 and 2, the related art holographic data recording/reproducing apparatus includes a data recording apparatus 20 and a data reproducing apparatus 30. The data recording apparatus 20 includes a light source 21, a beam splitter 22, and a focusing lens unit 23. The data reproducing apparatus 30 includes an objective lens 31 and an optical signal detection unit 32. The focusing lens unit 23 has a multi-focal length in order to focus both the reference beam and the signal beam. For example, the multi-focal lens is divided into a first area having a first focus P and a second area having a second focus Q. The light passing through the first area is focused at the first focus P while the light passing through the second area is focused at the second focus Q. Thus, when a laser beam emitted by the light source 21 is projected onto both of the first and second areas, the laser beam is divided into a first laser beam focused at the first focus P and a second laser beam focused at the second focus Q. One of the first and second laser beams is a signal beam and the other beam is a reference beam. Accordingly, interference between the signal beam and the reference beam occurs in a predetermined area of the data storage medium 10 and corresponding holographic data can be recorded thereto in the form of an interference pattern.

When the holographic data recording/reproducing apparatus reproduces information, only the reference beam is incident on the holographic data storage medium 10. For example, if it is defined that light passing through the first area of the focusing lens unit 23 is the reference beam, light is only allowed to pass through the first area of the focusing lens unit 23 when the holographic data recording/reproducing apparatus reproduces information. Accordingly, a signal beam generated by the reference beam being passed through an interference pattern in the holographic data storage medium 10 is focused at the optical signal detection unit 32 by the objective lens 31 to be reproduced.

The holographic data recording/reproducing apparatus can be classified into a type in which information is recorded/reproduced in bits and a type in which information is recorded/reproduced in pages using two-dimensional signal patterns. When information is recorded/reproduced in pages, information can be rapidly recorded/reproduced and recording density can be increased. However, since a high speed input-output device having a large area and an optical system having high resolution are required, manufacturing costs are extremely high. Accordingly, in the type manufactured at relatively low cost, in which information is recorded/reproduced in bits, there is a need to increase recording density and recording/reproducing speed. A type of holographic data recording/reproducing apparatus, in which information is recorded in the same location of a holographic data storage medium by changing a focus of a signal beam with respect to the same reference beam, has been suggested. In such a type, when a reference beam is incident to a holographic data storage medium in order to reproduce information, a plurality of signal beams having different focal points are generated on the same optical axis. Accordingly, there is a need for a reproducing apparatus which can simultaneously detect a plurality of signal beams having different focal points.

### SUMMARY OF THE INVENTION

The present invention provides a data reproducing apparatus, for use with a multilayered holographic data storage medium, which can simultaneously reproduce a large amount of information recorded at the same horizontal location of multiple layers of a holographic data storage medium.

The present invention also provides a photo detecting device which can detect a plurality of beams having focal points formed at different locations on the same optical axis.

According to an aspect of the present invention, there is provided a method of manufacturing a volume hologram device which diffracts a plurality of incident beams having focal points formed at different locations on the same optical axis to form secondary beams which travel in different directions, the method comprising: disposing alight source array comprising a plurality of light sources spaced predetermined intervals apart and a photosensitive material on either side of a lens; turning-on one of the light sources of the light source array so that a first light emitted from one of the light sources is incident on the photosensitive material though the lens; forming an interference pattern of the first light and a second light having interfered with each other in the photosensitive material by providing on the photosensitive material the second light having a focus formed at a location corresponding to a location of the first light in the photosensitive material; repeating the turning-on and the forming of interference patterns with respect to other sequential light sources of the light source array.

According to another aspect of the present invention, there is provided a photo detecting device comprising: a volume hologram device which diffracts a plurality of incident beams having focal points formed at different locations on the same optical axis to form secondary beams which travel in different directions; a fourier lens focusing the secondary beams formed by the volume hologram device; and an optical detector array detecting the secondary beams focused by the fourier lens.

Distances between the fourier lens and the center of the volume hologram device and between the fourier lens and the optical detector array may be each the focal length of the fourier lens.

The volume hologram device may be formed of one selected from the group consisting of a photorefractive crystal, a photorefractive polymer and a photopolymer.

The optical detector array may be a charge coupled device (CCD) or a photodiode array comprising a plurality of photodiodes.

According to another aspect of the present invention, there is provided a holographic data reproducing apparatus for reproducing a large amount of information recorded in multiple layers of a holographic data storage medium, the apparatus comprising: a focusing lens focusing a plurality of reproduced signal beams generated when a reference beam is incident on the holographic data storage medium, the plurality of reproduced signal beams having focal points formed at different locations on the same optical axis; a volume hologram device generating secondary signal beams which travel in different directions by diffracting the plurality of reproduced signal beams having different focal lengths; a fourier lens focusing the secondary signal beams generated from the volume hologram device; and an optical detector array detecting the secondary signal beams focused by the fourier lens.

### BRIEF DESCRIPTION OF THE DRAWINGS

The above and other aspects of the present invention will become more apparent by describing in detail exemplary embodiments thereof with reference to the attached drawings in which:

FIG. 1 shows the structure of a related art holographic data recording/reproducing apparatus;

FIG. 2 shows that data is recorded by a data recording apparatus in a data storage medium using the interference between a reference beam and a signal beam;

FIG. 3 is a schematic diagram illustrating a holographic data recording/reproducing apparatus for a multilayered holographic data storage medium, according to an exemplary embodiment of the present invention;

FIGS. 4A through 4D are views illustrating a method of recording information at multiple layers of the multilayered holographic data storage medium, according to an exemplary embodiment of the present invention;

FIGS. 5A through 5C are views illustrating paths of a plurality of reproduced signal beams RS focused in a volume hologram device 520, according to an exemplary embodiment of the present invention; and

FIGS. 6A through 6C are views illustrating a method of pre-forming an interference pattern in a volume hologram device, according to an exemplary embodiment of the present invention.

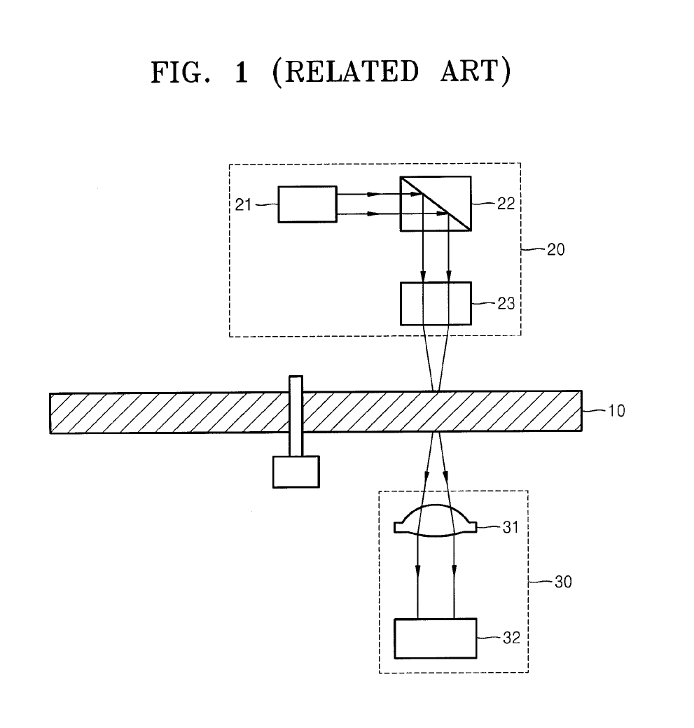

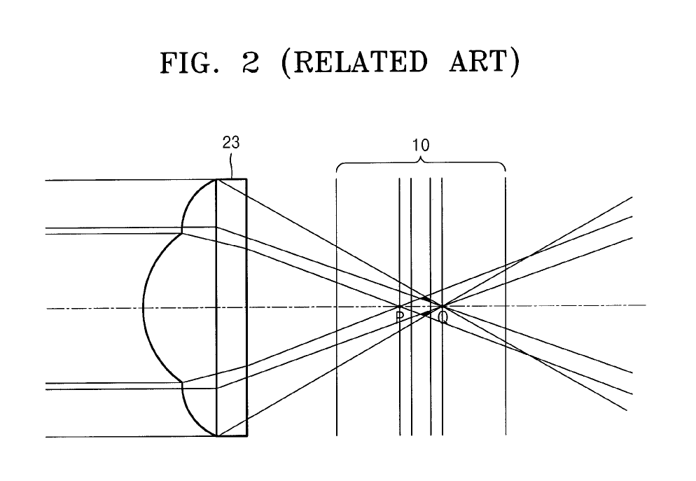

### DETAILED DESCRIPTION OF THE EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these exemplary embodiments are provided so that this disclosure will be thorough and complete, and will fully convey the concept of the invention to those skilled in the art.

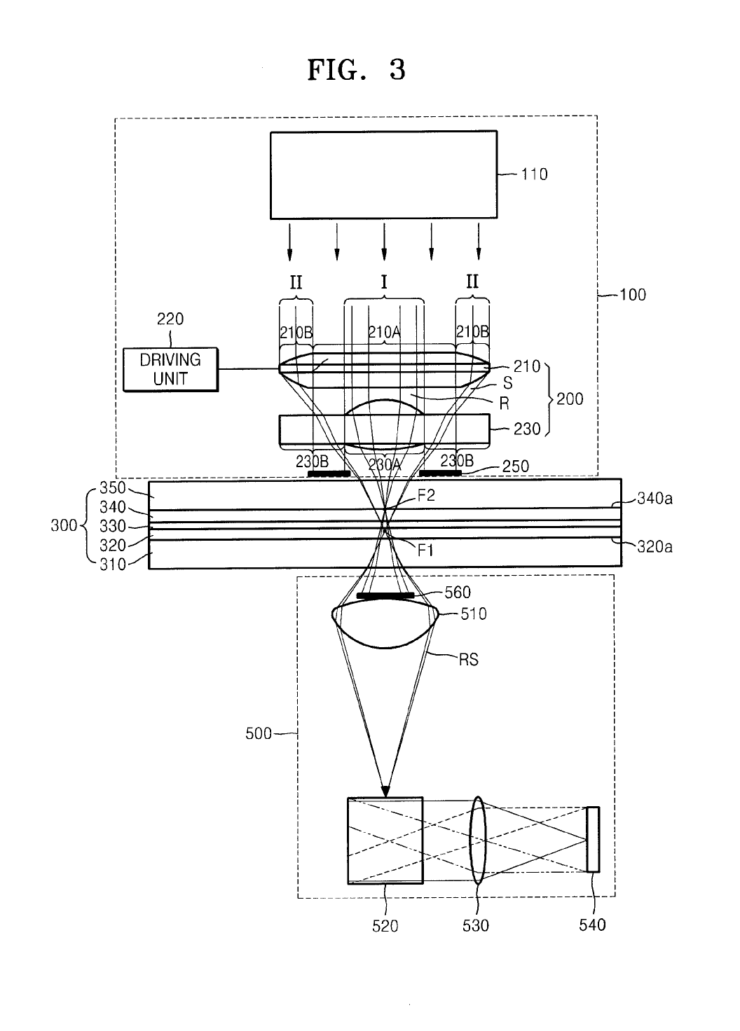

FIG. 3 is a schematic diagram illustrating a holographic data recording/reproducing apparatus for a multilayered holographic data storage medium, according to an exemplary embodiment of the present invention. Referring to FIG. 3, the holographic data recording/reproducing apparatus includes a data recording apparatus 100 and a data reproducing apparatus 500. The data recording apparatus 100 has a structure such that data may be recorded at the same horizontal location of multiple layers of the holographic data storage medium 300 by altering a focus of a signal beam with respect to the same reference beam. The data reproducing apparatus 500 has a structure such that data, which is recorded at the same horizontal location of the multiple layers of the holographic data storage medium 300, may be simultaneously reproduced.

First, a structure of the holographic data recording apparatus 100 will be described. Referring to FIG. 3, the holographic data recording apparatus 100 includes a light source 110 emitting a laser beam towards the holographic data storage medium 300, a lens unit 200 which divides a laser beam emitted from the light source 110 into a reference beam R passing through a first area I and a signal beam S passing through a second area II and focuses the reference beam R and the signal beam S, and a driving unit 220 driving the lens unit 200. The holographic data recording apparatus 100 may further include a beam splitter (not shown) disposed between the light source 110 and the lens unit 200 and redirecting an optical path according to the arrangement of the light source 110 so that light may travel towards the holographic data storage medium 300. In addition, the holographic data recording apparatus 100 may further include a collimating lens (not shown) collimating light emitted from the light source 110.

The classification of the laser beam light passing through the first area I as the reference beam R and the laser beam light passing through the second area II as the signal beam is exemplary. That is, light passing through the first area I may be a signal beam, and light passing through the second area II may be a reference beam.

The lens unit 200 includes a first lens 210 and a second lens 230. The combination of the first lens 210 and the second lens 230 focuses the signal beam S at a first focus F1 and focuses the reference beam R at a second focus F2. To achieve this, only an area of the first lens 210 corresponding to the signal beam S has refractive power. An area of the first lens 210 is divided into a first flat area 210A having no refractive power and a first lens area 210B disposed around the first flat area 210A and having refractive power. The first flat area 210A is an area through which an optical beam including the reference beam R passes, and the first lens area 210B is an area through which an optical beam including the signal beam S passes.

Only an area of the second lens 230 corresponding to the reference beam R has refractive power. The second lens 230 is divided into a second lens area 230A having refractive power and a second flat area 230B disposed around the second lens area 230A and having no refractive power. The second lens area 230A is an area through which an optical beam corresponding to the reference beam R passes. The second lens area 230A has a structure so that the reference beam R passing through the second lens area 230A may be focused at the second focus F2 in the holographic data storage medium 300. The second flat area 230B is an area through which an optical bean including the signal beam S passes, and is flat so as to have no refractive power.

The first beam blocking unit 250 may be disposed on an optical path between the second lens 230 and the holographic data storage medium 300. The first beam blocking unit 250 blocks an optical beam that passes through the first flat area 210A of the first lens 210 and the second flat area 230A of the second lens 230, that is, an optical beam, which does not correspond to the signal beam S and the reference beam R, such that it is not incident on the holographic data storage medium 300. For example, the first beam blocking unit 250 may be an aperture controlling a projected area on which an optical beam is incident.

However, a structure of the lens unit 200 is not limited to shapes of the first lens 210 and the second lens 230, and may have various structures so that an optical beam is divided into a signal beam and a reference beam which are respectively focused at the first focus F1 and the second focus F2, or vice versa. For example, the first flat area 210A of the first lens 210 may be an opening. In addition, the second lens 230 may be an objective lens having a diameter corresponding to the reference beam. The first flat area 210A and the second lens area 230A may have structures such that an optical beam of the first flat area 210A corresponds exactly with the second lens area 230A, and an optical beam of the first lens area 210B corresponds exactly with the second flat area 230B. In this case, the first beam blocking unit 250 is not necessary.

The driving unit 220 drives the first lens 210 so that the first focus F1 of the first lens 210 may be variable along a depth direction of the holographic data storage medium 300. For example, the driving unit 220 may include a voice coil motor, piezoelectric ultrasonic motor, or the like.

The holographic data storage medium 300 is a multilayered structure including a recording layer 330. For example, the holographic data storage medium 300 includes a substrate 310, and a first buffer layer 320, a recording layer 330, a second buffer layer 340 and a cover layer 350 which are sequentially formed on the substrate 310. A first reflective layer 320a is formed as an interface between the substrate 310 and the first buffer layer 320, and is formed so as to have partial reflectivity. A second reflective layer 340a is formed as an interface between the second buffer layer 340 and the cover layer 350, is formed so as to have partial reflectivity.

The holographic data reproducing apparatus 500 for reproducing a large amount of information recorded at the same horizontal location of multiple layers of the holographic data storage medium 300 is disposed on the opposite side of the holographic data storage medium 300 to the holographic data recording apparatus 100. The holographic data reproducing apparatus 500 includes a focusing lens 510, a volume hologram device 520, a fourier lens 530 and an optical detector array 540. The focusing lens 510 focuses a plurality of reproduced signal beams, which are generated while the reference beam passes through the holographic data storage medium 300, at the volume hologram device 520. The volume hologram device 520 diffracts the reproduced signal beams having different focal points and generates secondary reproduced signal beams which travel in different directions. The fourier lens 530 focuses the secondary reproduced signal beams generated by the volume hologram device 520 at the optical detector array 540. In order to do this, both of distances between the fourier lens 530 and the center of the volume hologram device 520 and between the fourier lens 530 and the optical detector array 540 may be the same as a focus length “f” of the fourier lens 530. The optical detector array 540 may include, for example, a two dimensional optical detector such as a CCD, or a photo diode array having a plurality of photo diodes. Using the holographic data reproducing apparatus 500, since the reproduced signal beams having different focal points are focused at different points of the optical detector array 540, the plurality of reproduced signal beams can be simultaneously detected.

The holographic data reproducing apparatus 500 may further include a second beam blocking unit 560 blocking light which is not a reproduced beam in order to detect only light corresponding to a reproduced beam among light signals generated by the holographic data storage medium 300. For example, the second beam blocking unit 560 can block a reference beam transmitted through the holographic data storage medium 300. For example, the second beam blocking unit 560 may be an aperture controlling a projected area. Although the second beam blocking unit 560 is disposed in front of the focusing lens 510 in FIG. 3, the second beam blocking unit 560 may be disposed behind the focusing lens 510.

The holographic data recording/reproducing apparatus records holographic information on a number of multiple layers of the holographic data storage medium 300 and reproduces the holographic information as follows.

An optical beam emitted from the light source 110 to the holographic data storage medium 300 includes the reference beam R having no information and the signal beam S having information to be recorded. For example, the signal beam S includes a laser beam of which intensity of light is modulated according to information to be stored. Light including the reference beam R is transmitted through the first flat area 210A of the first lens 210. Light corresponding to the reference beam R of transmitted through the first flat area 210A travels towards the second lens area 230A of the second lens 230, and the rest of the light travels towards the second flat area 230B of the second lens 230. The reference beam R transmitted through the second lens area 230A is focused at a predetermined point of the holographic data storage medium 300, which is the second focus F2. The second focus F2 may be formed on the second reflective layer 340a of the holographic data storage medium 300 in order to control tracking and a focusing servo. Light transmitted through the first flat area 210A and the second flat area 230B is blocked so as not to be incident on the holographic data storage medium 300.

Light corresponding to the signal beam S is transmitted through the first lens area 210B and then through the second flat area 230B of the second lens 230, and then is focused at a predetermined point of the holographic data storage medium 300, which is the first focus F1. The location of the first focus F1 is not limited to FIG. 3. That is, the location of the first focus F1 may be variable so that the reference beam R and the signal beam S may interfere to form interference fringes on the recording layer 330 of the holographic data storage medium 300. According to the current exemplary embodiment of the present invention, the driving unit 220 can drive the first lens 210 so that the location of the first focus F1 may be variable along the depth direction of the holographic data storage medium 300.

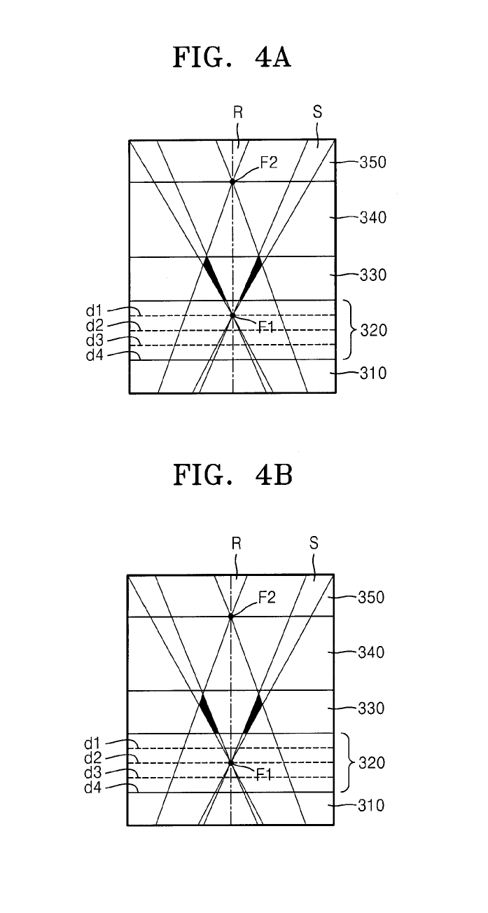

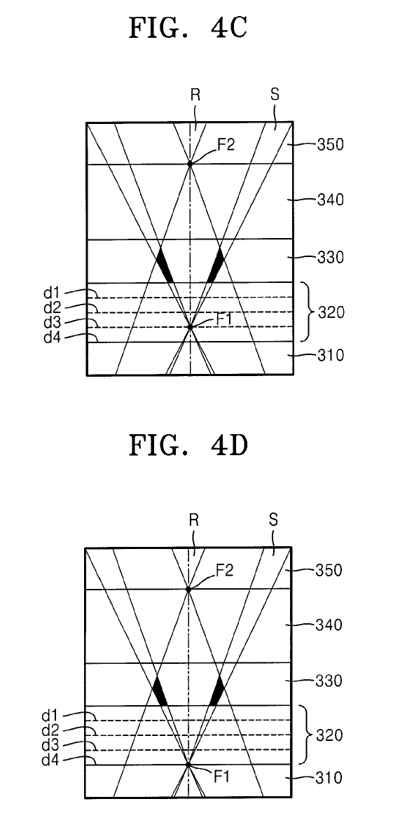

FIGS. 4A through 4D are views illustrating a method of recording information on the multilayered recording layer 330 of holographic data storage medium 300, according to an exemplary embodiment of the present invention. Referring to FIGS. 4A through 4D, a location, at which a reference beam R and a signal beam S interfere with each other in a recording layer 330 of the holographic data storage medium 300, is changed by moving a first focus F1, and thus information can be recorded in the multiple layers. FIGS. 4A through 4D are views illustrating the cases where the first focus F1 is formed on a first layer d1 through a fourth layer d4, respectively. The first layer d1 through the fourth layer d4 are illustrated in order to show the case where the first focus F1 of the signal beam is moved along a depth direction of the holographic data storage medium 300, and the first layer d1 through the fourth layer d4 are not physical interfaces. As the first focus F1 is moved along the depth direction of the holographic data storage medium 300, a location, at which interference fringes of the reference beam R and the signal beam S are formed, is slightly changed. A moving interval of the first focus F1 can be determined so that interference fringes may be resolved and reproduced. Although the first focus F1 is moved in the first buffer layer 320 in FIGS. 4A through 4D, the present invention is not limited thereto. For example, if interference fringes formed by interference between the reference beam R and the signal beam S are moved in the recording layer 330, the first focus F1 can be moved in another layer of the holographic data storage medium 300. Accordingly, a large amount of information can be recorded at the same horizontal location of multiple layers of the holographic data storage medium 300.

In order to reproduce information recorded in the holographic data storage medium 300, only the reference beam R is incident on the holographic data storage medium 300 through a second lens area 230A of a second lens 230. Then, when the reference beam R is incident on the holographic data storage medium 300, a plurality of signal beams RS having different focal points are simultaneously reproduced. Only one reproduced signal beam RS is illustrated in FIG. 3 for convenience. The reproduced signal beams RS are focused in a volume hologram device 520 by a focusing lens 510.

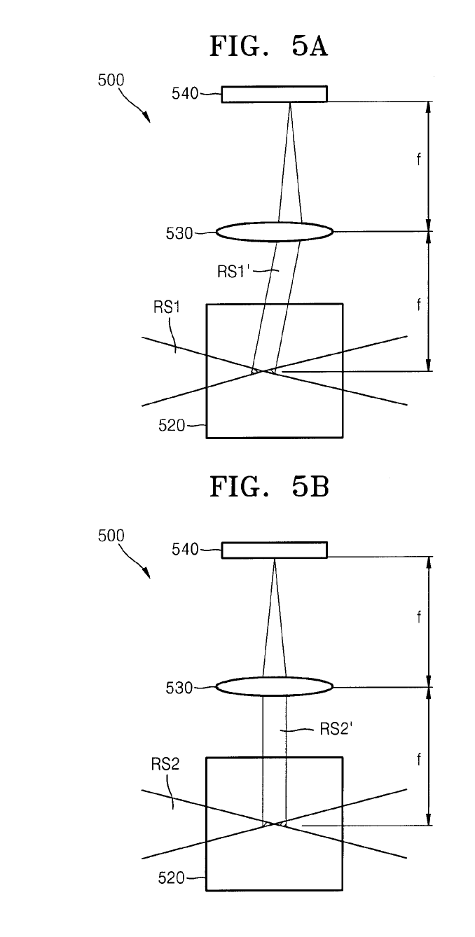

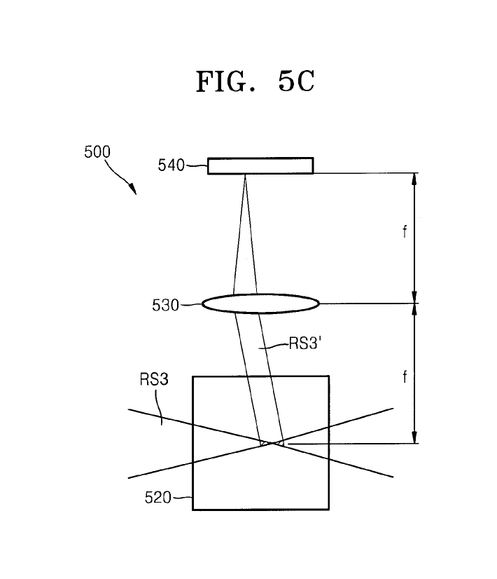

FIGS. 5A through 5C are views illustrating paths of a plurality of reproduced signal beams RS focused in a volume hologram device 520, according to an exemplary embodiment of the present invention. Referring to FIGS. 5A through 5C, focal points of the reproduced signal beams RS1 to RS3 focused by a focusing lens 510 are formed on different locations in the volume hologram device 520. For example, the focus of the first reproduced signal beam RS1 is formed close to an incidence surface of the volume hologram device 520, the focus of the second reproduced signal beam RS2 is formed close to a center of the volume hologram device 520, and the focus of the third reproduced signal beam RS3 is formed farthest from the incidence surface of the volume hologram device 520. Although the reproduced signal beams RS1 to RS3 are respectively illustrated in FIGS. 5A through 5C for convenience, in actuality the reproduced signal beams RS1 to RS3 are simultaneously incident on the volume hologram device 520.

Since the volume hologram device 520 includes an interference pattern which is pre-formed inside the volume hologram device 520, each of the reproduced signal beams RS1 to RS3 are diffracted to generate secondary reproduced signal beams which travel in different directions. For example, a first secondary signal beam RS1′ generated by diffracting the first reproduced signal beam RS1 by the volume hologram device 520 travels towards the right side of the fourier lens 530 to be focused at the right side of the optical detector array 540. A second secondary signal beam RS2′ generated by diffracting the second reproduced signal beam RS2 by the volume hologram device 520 is transmitted through the center of the fourier lens 530 to be focused at the center of the optical detector array 540. A third secondary signal beam RS3′ generated by diffracting the third reproduced signal beam RS3 by the volume hologram device 520 travels towards to the left side of the fourier lens 530 to be focused at the left side of the optical detector array 540. Accordingly, the secondary signal beams RS1′ to RS3′ generated by the reproduced signal beams RS1 to RS3, of which focal points are formed at different locations of the volume hologram device 520, are focused at different locations of the optical detector array 540. According to the current exemplary embodiment of the present invention, a large amount of information recorded at the same horizontal location of the holographic data storage medium 300 can be detected and reproduced simultaneously.

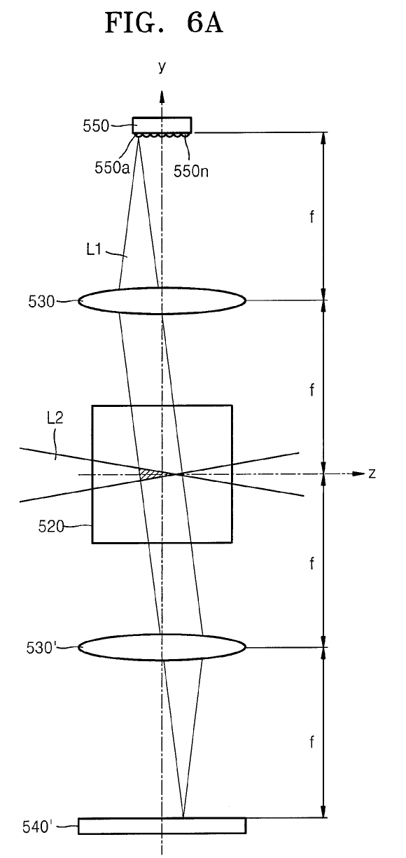

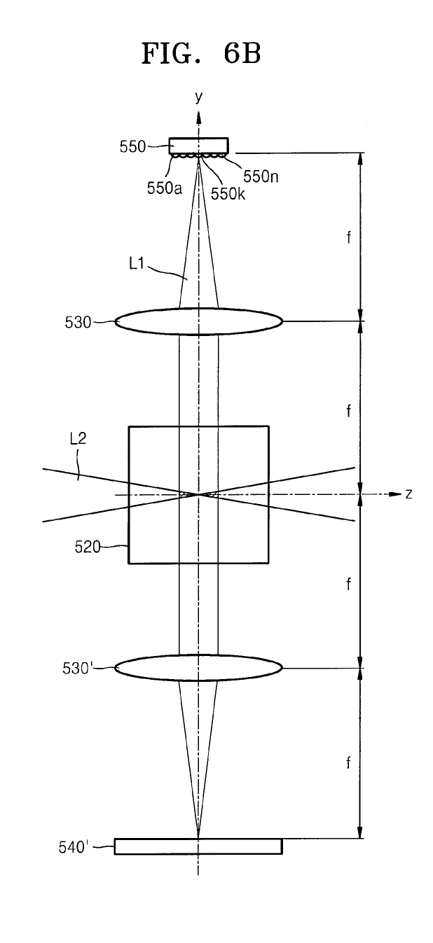

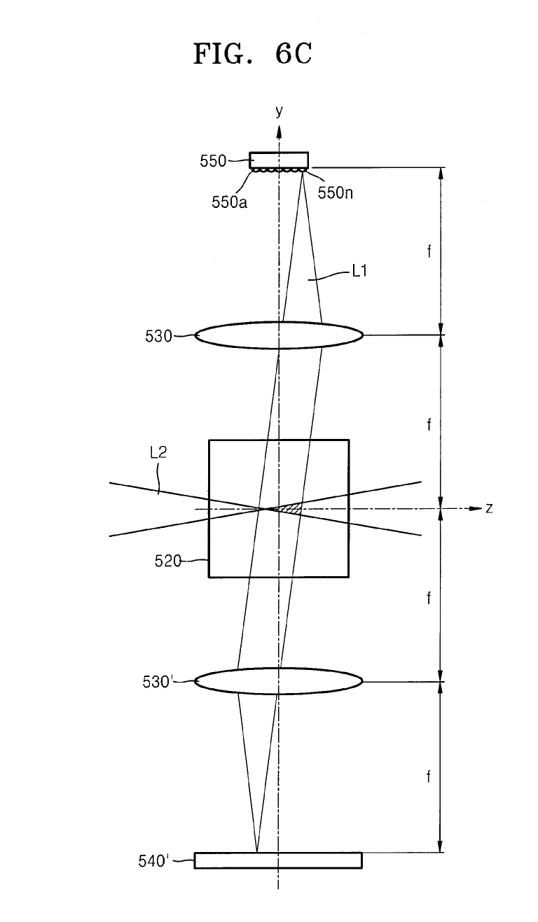

FIGS. 6A through 6C are views illustrating a method of pre-forming an interference pattern in a volume hologram device 520, according to an exemplary embodiment of the present invention. Referring to FIGS. 6A through 6C, a light source array 550 and a volume hologram device 520 are disposed at focal points on either side of a fourier lens 530. That is, a distance between the fourier lens 530 and the light source array 550 is equal to a focal length f of the fourier lens 530, and a distance between the fourier lens 530 and the center of the volume hologram device 520 is also equal to the focal length f of the fourier lens 530. The light source array 550 includes a plurality of light sources 550a to 550n spaced predetermined intervals apart. The volume hologram device 520 may be formed of a photosensitive material which is the same material as that of a recording layer 330 of the holographic data storage medium 300 described above. For example, the volume hologram device 520 may be formed of a photorefractive crystal, a photorefractive polymer or a photopolymer. Although not illustrated, only a part of the volume hologram device 520, on which light is interfered or diffracted, is formed of a photosensitive material similarly to the holographic data storage medium 300, and other parts may be formed of a transparent cover layer.

Next, referring to FIG. 6A, light L1 emitted from the first light source 550a by turning-on the first light source 550a travels inside the volume hologram device 520 via the fourier lens 530. Simultaneously, light L2 having a specific focal position and traveling in a z-axis direction is incident inside the volume hologram device 520 through a side surface of the volume hologram device 520. The wavelengths and the phases of the two kinds of light L1 and L2 may be controlled so as to interfere with each other. In particular, the two kinds of light L1 and L2 may have the same wavelength as that of a signal beam or a reference beam used in recording information in the holographic data storage medium 300. Accordingly, an interference pattern generated by the two kinds of light L1 and L2 interfered with each other is recorded at a specified position (a hatched portion) in the volume hologram device 520.

Referring to FIGS. 6B and 6C, other light sources of a kₜₕ light source 550k to a nₜₕ light source 550n are sequentially turned-on, light L1 emitted from each of the light sources is incident on the volume hologram device 520 via the fourier lens 530. Simultaneously, light L2 having a focal position corresponding to the light L1, which is emitted from each of the light sources, and capable of interference with the light L1, is sequentially incident on the volume hologram device 520. Accordingly, interference patterns can be multiply recorded at different locations on a z-axis in the volume hologram device 520.

A secondary beam is generated and detected using the volume hologram device 520 manufactured by the above method by one of the following two methods.

First, the optical detector array 540 as illustrated in FIGS. 5A through 5C is placed in the position of the light source array 550 as illustrated FIGS. 6A through 6C. When light having a specified focal point is incident on the volume hologram device 520 in an opposite direction (that is, a negative z-axis direction) to the traveling direction of the light L2, the light L1 corresponding to the specified focus point in recording is reproduced to be incident on a specified location of the optical detector array 540 through the fourier lens 530 according to a principle of a phase conjugate hologram. Accordingly, the reproducing apparatus 500 is manufactured so that the optical detector array 540 of FIGS. 5A through 5C may be disposed in the position of the light source array 550 of FIGS. 6A through 6C. In addition, the volume hologram device 520 is disposed so that an opposite surface to a surface on which light L2 is incident as illustrated in FIGS. 6A through 6C may face the focusing lens 510 of FIG. 3. Accordingly, referring to FIGS. 5A through 5C, reproduced signal beams having different focal points can be incident on different locations of the optical detector array 540.

Second, referring to FIGS. 6A through 6C, an additional fourier lens 530′ and optical detector array 540′ are respectively disposed at equivalent locations of the fourier lens 530 and the light source array 550 on the other side of the volume hologram device 520. Light having a specified focus is incident on the volume hologram device 520 in the same direction (that is, a +z-axis direction) as the traveling direction of the light L2. Accordingly, the light L1 corresponding to the specified focus in recording is reproduced to be incident on a specified location of the optical detector array 540′ through the fourier lens 530′. Accordingly, the reproducing apparatus 500 is manufactured so that the additional fourier lens 530′ and optical detector array 540′ are respectively disposed on a opposite side of the volume hologram device 520 to the side of the fourier lens 530 and the light source array 550 illustrated in FIGS. 6A through 6C. In addition, the volume hologram device 520 is disposed so that a surface on which the light L2 is incident as illustrated in FIGS. 6A through 6C may face the focusing lens 510 of FIG. 3.

The method of simultaneously detecting and reproducing information stored in same horizontal location of multiple layers of the holographic data storage medium 300 using the volume hologram device 520 has been described above. However, the volume hologram device 520 can be used in different various apparatuses as well as a holographic information reproducing apparatus. That is, the volume hologram device 520 can be used in every apparatus in which a plurality of incident beams having focal points formed at different locations on the same optical axis are detected and detected results are used. For example, light having an unknown focal position is incident on the volume hologram device 520, and then a location, at which a focus of the light is formed, can be correctly calculated. Using this, the volume hologram device 520 can be used in an automatic focusing apparatus such as a camera.

According to the exemplary embodiments of the present invention, the holographic reproducing apparatus using the volume hologram device can simultaneously reproduce a large amount of information recorded at the same horizontal location of multiple layers of the holographic data storage medium. Accordingly, data can be rapidly reproduced. In addition, in order to reproduce a plurality of signal beams formed on different locations on the same optical axis, optical detectors need not be mechanically moved along the axis direction.

According to the exemplary embodiments of the present invention, there is provided a photo detecting device which can detect a plurality of beams having focal points formed at different locations on the same optical axis.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing a volume hologram device which diffracts a plurality of incident beams having focal points formed at different locations on the same optical axis to form secondary beams which travel in different directions, the method comprising:
disposing a light source array comprising a plurality of light sources and a photosensitive material on opposite sides of a lens;
turning-on a light source of the plurality of light sources of the light source array so that a first light emitted from the light source is incident on the photosensitive material though the lens;
forming an interference pattern of the first light and a second light which interferes with the first light in the photosensitive material by causing the second light to be incident on the photosensitive material, the second light having a focus formed at a location corresponding to a location of the first light in the photosensitive material;
repeating the turning-on and the forming of the interference pattern with respect to other sequential light sources of the plurality of light sources.

2. The method of claim 1, wherein each of a distance between the lens and the photosensitive material and a distance between the lens and the light source array is a focal length of the lens.

3. The method of claim 1, wherein the photosensitive material comprises one of a photorefractive crystal, a photorefractive polymer and a photopolymer.

4. A photo detecting device comprising:
a volume hologram device which diffracts a plurality of incident beams having focal points formed at different locations on a same optical axis to form a plurality of secondary beams which travel in proceeding directions;
a fourier lens which focuses the plurality of secondary beams formed by the volume hologram device; and
an optical detector array which detects the plurality of secondary beams focused by the fourier lens.

5. The photo detecting device of claim 4, wherein each of a distance between the fourier lens and a center of the volume hologram device and a distance between the fourier lens and the optical detector array is a focal length of the fourier lens.

6. The photo detecting device of claim 4, wherein the volume hologram device comprises one of a photorefractive crystal, a photorefractive polymer and a photopolymer.

7. The photo detecting device of claim 4, wherein the optical detector array is a charge coupled device or a photodiode array comprising a plurality of photodiodes.

8. A holographic data reproducing apparatus for reproducing a large amount of information recorded in multiple layers of a holographic data storage medium, the apparatus comprising:
a focusing lens which focuses a plurality of reproduced signal beams generated when a reference beam is incident on the holographic data storage medium, the plurality of reproduced signal beams having focal points formed at different locations on a same optical axis;
a volume hologram device which generates a plurality of secondary signal beams which travel in different directions by diffracting the plurality of reproduced signal beams having different focal lengths;
a fourier lens which focuses the plurality of secondary signal beams generated from the volume hologram device; and
an optical detector array which detects the plurality of secondary signal beams focused by the fourier lens.

9. The apparatus of claim 8, wherein each of a distance between the fourier lens and a center of the volume hologram device and a distance between the fourier lens and the optical detector array is a focal length of the fourier lens.

10. The apparatus of claim 8, wherein the volume hologram device comprises one of a photorefractive crystal, a photorefractive polymer and a photopolymer.

11. The apparatus of claim 8, wherein the optical detector array is a charge coupled device or a photodiode array comprising a plurality of photodiodes.

12. The apparatus of claim 8, wherein the volume hologram device is fabricated using the method of claim 1.
